(19) United States
(12) Patent Application Publication
(10) Pub. No.: US 2007/0032138 A1
(43) Pub. Date: Feb. 8, 2007

(54) Apparatus and Method for Stabilizing, Strengthening, and Reinforcing Block/Brick (CMU) Wall Construction

(76) Inventor: Armando Quinones, La Luz, MN (US)

Correspondence Address: PEACOCK MYERS, P.C., 201 THIRD STREET, N.W., SUITE 1340, ALBUQUERQUE, NM, 87102, US

(21) Appl. No.: 11/462,288

(22) Filed: Aug. 3, 2006

Related U.S. Application Data
(60) Provisional application No. 60/706,356, filed on Aug. 5, 2005.

(51) Int. Cl. H01R 9/22

(52) U.S. Cl. 439/717

(57) ABSTRACT

An apparatus for and method for constructing and reinforcing modular block construction comprising placing on one or more modular blocks a plurality of chamfered pins, connecting the pins via a plurality of connectors, and aligning via the pins modular blocks placed in a layer above the connectors.

### CROSS-REFERENCE TO RELATED APPLICATIONS

This application claims priority to and the benefit of the filing of U.S. Provisional Patent Application Ser. No. 60/706,356, entitled “Apparatus and Method for Constructing and Reinforcing Modular Block Construction”, filed on Aug. 5, 2005, and the specification and claims thereof are incorporated herein by reference.

### STATEMENT REGARDING FEDERALLY SPONSORED RESEARCH OR DEVELOPMENT

Not Applicable.

### INCORPORATION BY REFERENCE OF MATERIAL SUBMITTED ON A COMPACT DISC

Not Applicable.

### COPYRIGHTED MATERIAL

Not Applicable.

### BACKGROUND OF THE INVENTION

1. Field of the Invention (Technical Field)

The present invention is of an apparatus and method for rapidly constructing and reinforcing block walls and other constructions.

2. Description of Related Art

Note that the following discussion refers to a number of publications by author(s) and year of publication, and that due to recent publication dates certain publications are not to be considered as prior art vis-à-vis the present invention. Discussion of such publications herein is given for more complete background and is not to be construed as an admission that such publications are prior art for patentability determination purposes.

Existing spacing systems for modular block walls suffer from various deficiencies, including being too complex or structurally too rigid. Exemplary of the prior art are U.S. Patent Publication Nos. 2006/0070336 and 2004/0182029, and U.S. Pat. Nos. 6,840,019, 6,629,393, 6,553,737, 4,793,104, 4,334,397, and 4,229,922. The efficacy of the present invention in resistance to blasts, wind, and seismic activity is shown in Ho, C.K., et al., Finite Element Stress Analyses of Ties for Masonry Applications: Final Report for The Arquin Corporation, SAND2005-5877, Sandia National Laboratories, NM (Aug. 18, 2005).

### BRIEF SUMMARY OF THE INVENTION

The present invention is of an apparatus for and method for constructing and reinforcing modular block construction, comprising: placing on one or more modular blocks a plurality of chamfered pins; connecting the pins via a plurality of connectors; and aligning via the pins modular blocks placed in a layer above the connectors. In the preferred embodiment, the pins comprise holes or grooves and the connectors comprise rods, wherein the holes or grooves are sized to engagingly receive ends of the rods and a plurality of the pins have two or three holes or grooves receiving three rods, one of the three rods being perpendicular to the other two of the three rods. One or more of the pins comprise two holes or grooves receiving two rods, the two rods being perpendicular to one another. The pins comprise a rigid, non-porous, water repellent material, preferably an injection molded plastic. The pins are preferably chamfered on two sides of an upwardly extending portion.

Objects, advantages and novel features, and further scope of applicability of the present invention will be set forth in part in the detailed description to follow, taken in conjunction with the accompanying drawings, and in part will become apparent to those skilled in the art upon examination of the following, or may be learned by practice of the invention. The objects and advantages of the invention may be realized and attained by means of the instrumentalities and combinations particularly pointed out in the appended claims.

### BRIEF DESCRIPTION OF THE SEVERAL VIEWS OF THE DRAWINGS

The accompanying drawings, which are incorporated into and form a part of the specification, illustrate one or more embodiments of the present invention and, together with the description, serve to explain the principles of the invention. The drawings are only for the purpose of illustrating one or more preferred embodiments of the invention and are not to be construed as limiting the invention. In the drawings:

FIGS. 1a and 1b are views of a first embodiment of the separator/joiner component of the invention;

FIGS. 2a-e are additional views of the first embodiment;

FIGS. 3a and 3b are views of the first embodiment used with modular blocks;

FIGS. 4a and 4b are additional views of the first embodiment used with modular blocks;

FIG. 5 is a side view of a second embodiment of the separator/joiner of the invention;

FIGS. 6a and 6b are views of a preferred seperator/joiner connection system of the invention in conjunction with stacked modular blocks;

FIGS. 7a-c are detailed views of the embodiment of FIG. 6(b);

FIGS. 8a-f show further alternative embodiments;

FIGS. 9a and 9b are views of a T-clip embodiment of the invention;

FIG. 10 is a view of a single-strand version of the T-clip used in conjunction with a single connector; and

FIG. 11 is a flow diagram of a method of fabrication of a modular block wall according to the invention.

### DETAILED DESCRIPTION OF THE INVENTION

The present invention comprises a separator and joiner system for the spacing, joining and reinforcement of masonry or other building materials and its method of use. The system is preferably injection molded although other materials/methods can be used. The separator/joiner preferably comprises a rigid, non-porous, water repellent, injection molded material that can support the weight stresses of the materials that it is separating or joining. The separator/joiner may alternatively be manufactured using extruding, stamping, casting, or other methods known in the art. The materials for the separator/joiner include but are not limited to plastic, recycled molded plastic, metals, wood, and/or other materials. The material chosen must be strong enough to support the weight of the modular construction without significantly deforming. A few preferred materials are polypropylene, polyethylene, ABS (plastic styrene), or acrylic, or less preferably PVC or PTFE (Teflon). The present invention preferably comprises a unique rail and clip/pin system that can be utilized in a “separator” or “joiner” configuration, depending on the “pin” position. The pin, as used throughout the specification and claims, is the portion of the preferred embodiment which has been chamfered to ease block placement.

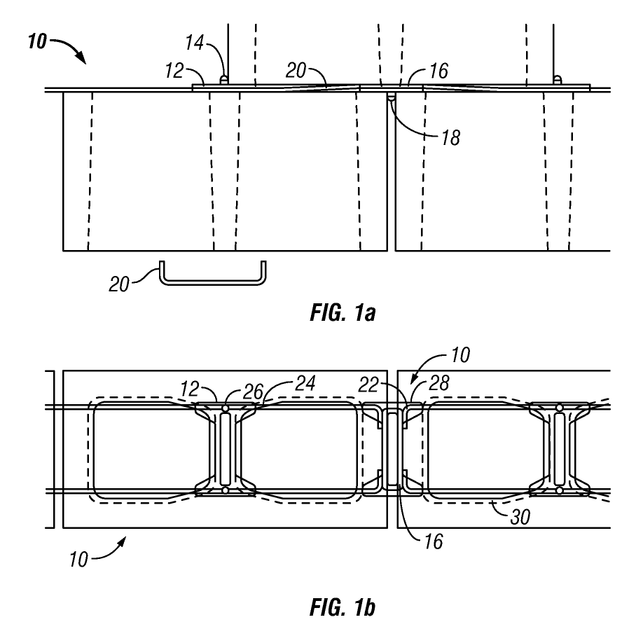

As a separator, or in the pin down position, the invention is preferably placed latitudinally between modular blocks and is connected to each modular block by some type of connector. The pin component of the unit uniformly separates the modular blocks. The ends of the invention press into the mating grooves of the modular blocks. As a joiner, or in the pin up position, the invention is preferably placed, latitudinally, inside the unit, and connectors are used to hold at least one modular block on top of another modular block (see FIGS. 1 through 5) and thereby providing a uniform and stable wall unit. Some kind of joining material, including, but not limited to grout, is generally placed between each separated/joined modular block. Because each modular block can be stabilized, it can be worked on as individual modular blocks or multiple modular blocks more efficiently. The advantages are that a very uniform and straight wall unit can be built, the wall unit is stronger because the joining and filling material, e.g. grout fill, is poured all at once and not on top of dried grout (creating a monolithic support), and approximately three times as many blocks can be laid during the same time. The present invention is applicable to any construction using modular blocks, including but not limited to concrete modular units (CMUs), concrete blocks, bricks, plastics, glass, fiberglass, rebar, concrete block substitutes, straw, environmentally friendly modular blocks, adobe, wood, metal, and the like.

The separator/joiner system preferably comprises one or two wires which run on top of the blocks. There is a separator/joiner which is at fixed intervals along the wire and fits between the blocks. The method of use includes, but is not limited to: 1) create a mortar bed, lay the separator/joiner system, and build a first row of blocks; (2) lay the second separator/joiner system and build the second row of blocks, etc.; (3) repeat these steps, etc.; (4) build the entire wall unit without using mortar; (5) pour a joining material down the top holes and a filling material, e.g. grout fill or concrete; and (6) apply joining and filling materials laterally into the side cracks, e.g. spraying mortar or plaster.

A wall unit includes, but is not limited to any building structure having one or more modular blocks, including but not limited to walls, fences, roofs, ceilings, and floors. Joining materials include but are not limited to, grout, fill, mud, cement, caulking, glues, environmentally friendly substitutes, and any similar materials used between modular blocks. Connectors include, but are not limited to clips, wires, pins, poles, and the like. Worked or working on a modular block is any manipulation of the modular block including, but not limited to wiring, plumbing, shoring, stuccoing, framing, and the like. A pour includes, but is not limited to any application of joining or filling material.

The present invention preferably has ends that close and open in order to make possible the connection with the next modular block or separator/joiner. A corner clip may optionally be provided for tying the unit at right angles, when necessary. The present invention is preferably kept in place by connectors. The length, width and size of the present invention vary appropriately to support the building materials.

An alternative bow-tie shaped embodiment of the present invention is shown in FIGS. 1-5. FIG. 1a shows the invention in the up position where it is used as separator 12 and in the down position as joiner 16. A separator includes, but is not limited to, use of the present invention as a building support mechanism to reinforce, separate, measure, and the like. A joiner includes, but is not limited to, use of the present invention as a building support mechanism to reinforce, tie, support, join, and the like. The positions are based on the direction of pin up 14 or pin down 18. The pin of the invention includes but is not limited to the protruding portion which has been chamfered, beveled, furrowed, or grooved to allow for ease of modular block placement.

FIG. 1b shows a top view of the up position as separator 12 and joiner 16. In pin up position 14, the invention is placed latitudinally across the top of the modular block and is connected with a connector, including but not limited to track connectors or wires 20, which run up and through grooves 24 and holes 26 (see FIG. 1b) for connection to the modular blocks and to the next joiner 16.

In pin down position 16, the joiner is placed between modular blocks and connected with connectors, which run through the grooves. Legs 22 are bent and press into modular block material mating grooves 28 for further stability and bent legs 22 are tapped into the grooves of modular block 30 and then can accept connectors, including wire. This system resists the tensile forces on the connectors and allows the continuous and uniform support of the wall unit. The present invention may also be used as a vertical separation and joining system.

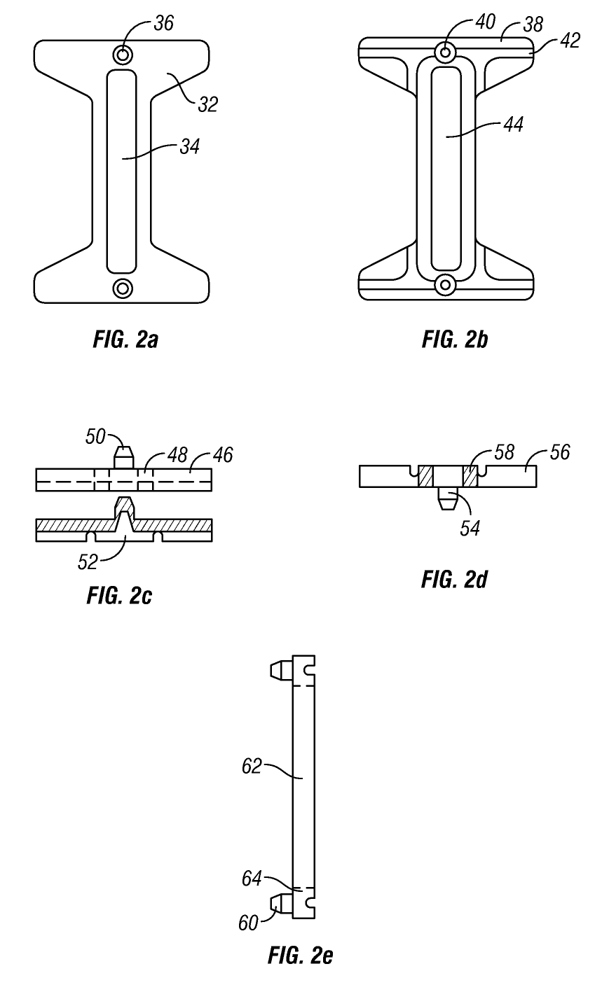

FIGS. 2a through 2e show different views of the invention including sectional views. FIG. 2a shows the invention in the up position as separator 32 with pin 34 facing up and holes 36 for any connectors. FIG. 2b shows the invention as joiner 38 in pin down 44 position. Holes 40 and grooves 42 allow for connectors to run up and through completing the system. FIG. 2c is a side view of separator/joiner 46 in the pin up position 50, showing the grooves/holes 48 for connection. FIG. 2c also shows the opening 52 which allows for the separator/joiner to be nested and stacked for ease of shipping and handling. FIG. 2d is a diagram of separator/joiner 56 in pin down 54 and grooves/holes 58 for connection. FIG. 2e is a side view of the separator/joiner 64 in a vertical pin position 60 holding a vertical modular block 62.

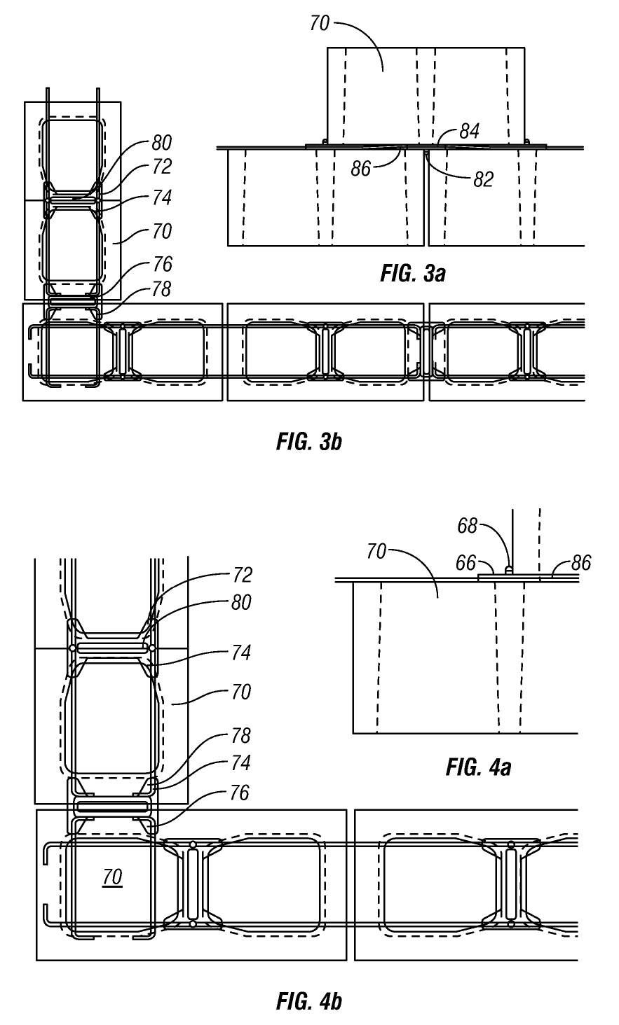

FIGS. 3a and 3b are additional views of the separator/joiner connection system in use with modular blocks. Separator 66, 72 in pin 68, 80 up position, latitudinally placed within modular block 70 with grooves 74 for connectors 86 and joiner 76 in pin 82 down position with bent legs 78 are shown in FIGS. 3a and 3b.

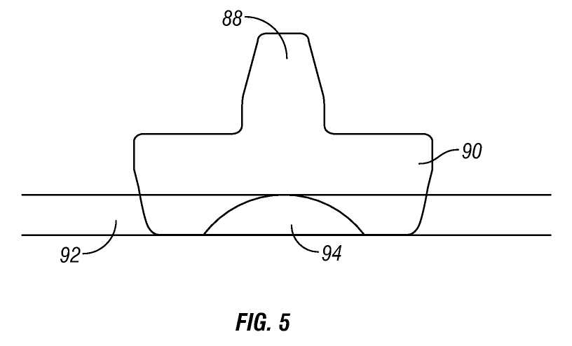

Separator 66, 72 in pin 68, 80 up position, latitudinally placed within modular block 70 with grooves 74 for connectors 86 and joiner 76 in the pin down position with bent legs 78 are shown in FIGS. 4a and 4b, in another view. FIG. 5 shows an alternative embodiment of separator/joiner 90 in pin 88 up position. Connector 92 runs through groove 94 to complete the system.

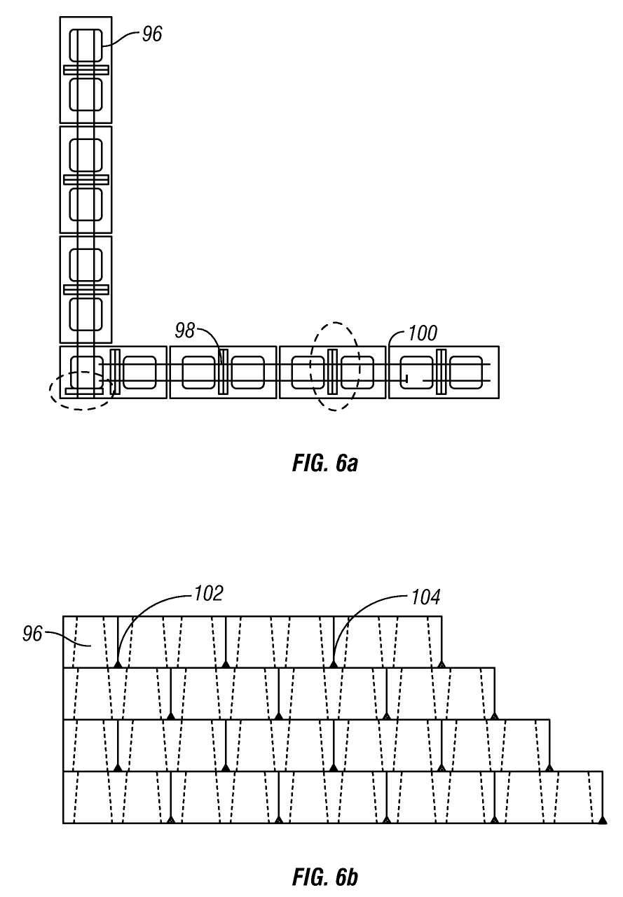

FIGS. 6a and 6b show a preferred embodiment of the separator/joiner connection system. The system comprises two strands of rigid metal wire onto which are crimped at precise intervals a “T” configured separator which provides a seat for modular sized masonry units. The “T” separator is preferably manufactured of a rigid, non-porous, man-made material that is rated to support the weight stresses of the wall units where they are used. The respective ends of each length of stranded separators are (1), closed by a separator and, (2), open on both strands in order to enable the connection with the next tie unit. There is optionally a corner clip that is provided for the purpose of tying at right angles. The length of the overall unit, and the intervals between the “T” separators vary in accordance with the modular sizes of the various masonry units, e.g. 4″×4″×16″; 8″×8″×16″; 2″×4″×8″; etc.

FIG. 6a shows modular block 96 with latitudinally placed separator 98 connected by connectors 100. Connectors 100 preferably comprise 9 gauge wire (or smaller), but may comprise cold roll, e.g. with a 3/16 diameter. The connectors are preferably straightened using a straightener during product manufacture. As can be seen, the inclusion of the present invention in the wall does not impede any vertical rebar that may be placed in the cells (i.e. openings) of the CMUs. However, the wires or rods are preferably close enough so that they are within the cell area, and are thus incorporated in the vertical pour. Because the connectors provide tensile strength, they can reduce the need for vertical rebar, and may require less frequent vertical pours, for example only every fourth block.

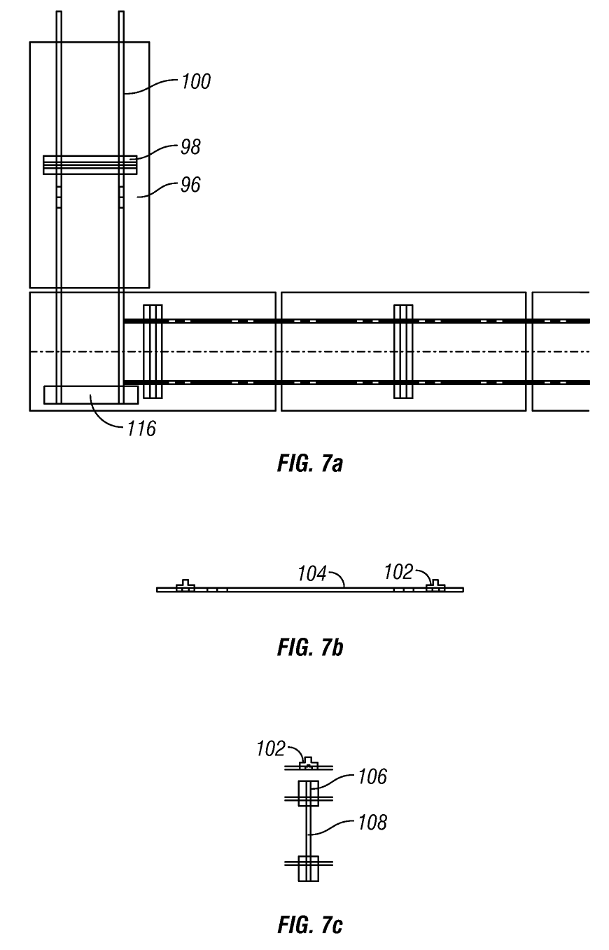

FIG. 6b shows an elevation view of modular blocks 96 with separator 102 and connector 104. FIGS. 7a through 7c show a detailed view of this embodiment. Modular block 96 with latitudinally placed separator 98 and connector 100 are shown in FIG. 7a. In FIG. 7b, separator 102 with connector 104 shows the basic rail system of the present invention. The rail system is also shown in FIG. 7c in separator 102, 106 and connector 108.

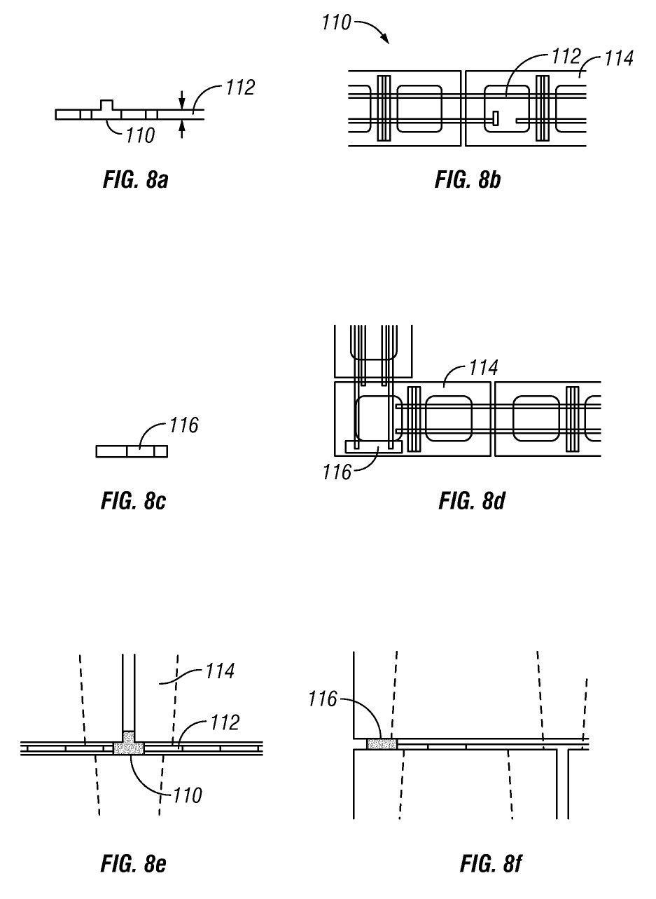

FIGS. 8a through 8f show different views of alternative embodiments of the present invention. FIGS. 8a, 8b, and 8e show an alternative embodiment of the system that is similar to the preferred embodiment. Separator/joiner 110 uses grooves and holes for connector 112 to connect modular blocks 114. FIGS. 8c, 8d and 8f show an embodiment using flat corner clip 116 to allow for a smooth corner transition. Flat corner clip 116 optionally utilizes connectors 112 to connect modular blocks 114 at the corners. Preferably a single rail unit (which is preferably four feet long to cover three standard CMUs, but can be any length), does not have a spacer at either end; the user can provide a flat corner clip if desired, or a standard “T” clip if the unit is to be joined to another unit, for example to form a long wall.

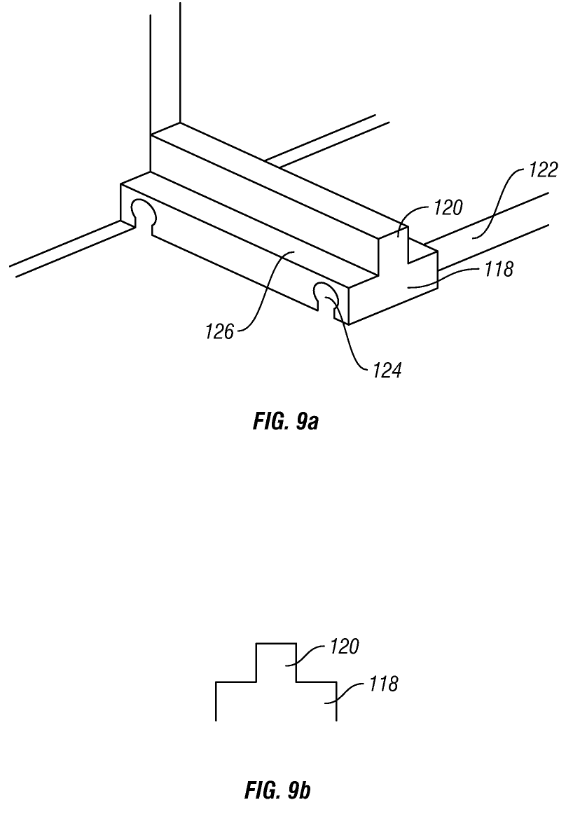

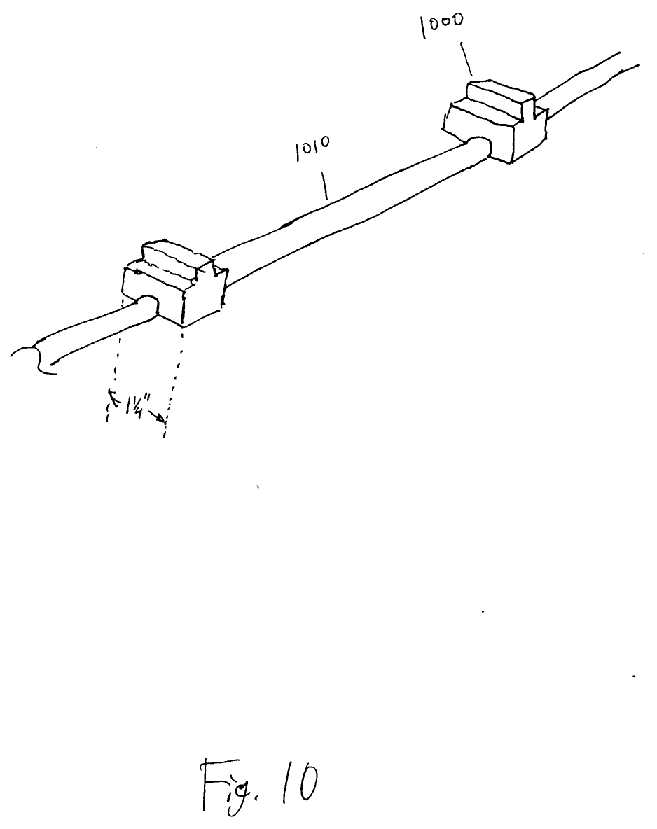

FIGS. 9a and 9b show a detail of the “T” clip of the present invention. FIG. 9a shows a cross view of the separator/joiner 118 with pin 120 up position and connector 122 for the rail system, holes 124 and grooves 126 for connection and modular block placement. FIG. 9b is a side view of alternative embodiment of separator/joiner 118 in pin 120 up position and pin 120 in both FIGS. 9a and 9b has not been chamfered. The grooves for the rods may comprise the shape shown, or may simply be arched with straight side walls. Preferably the rods or wires may be snapped, tapped, or slid into the grooves in the field. The “T” clip preferably comprises a marking in the middle of the bottom side, so the user can easily snap a clip onto the ends of wires so they extend only halfway into the clip grooves; thereafter an adjacent unit's wires may be snapped in the remaining half, thereby extending the present system to any desired length.

The preferred embodiment of the present invention is similar to the previous embodiment, except that single “T” clip 1000 is wide enough to hold only one connector (rod) 1010. One strand, or continuous filament masonry tie, of this embodiment is shown in FIG. 10. A preferred width is 1.25″, but any width could be used. The wider the clip, the safer the construction and the easier it is to install, but placement is limited as described below. During construction, two such strands are preferably used side by side; they are aligned parallel by the faces and shoulders of the “T” clips placed against the modular blocks. The strands are preferably placed so that they are both within the cell area and are thus incorporated into the vertical pour. However, one strand may optionally be moved closer to the center, or to any position, so it can be tied to the vertical rebar (using, for example, tie wire) as required by the architect. Such flexible placement is limited only by the width of the clips, which set the minimum separation distance between the strands.

Because the spacing is variable, any width modular block may be accommodated by just one product configuration. (According to the previous embodiment, multiple “T” clips must be manufactured and stocked to correspond to different sized modular blocks, for example bricks.) Any width modular blocks are accommodated by varying the number of parallel strands laid. For example, for pilaster or other wide block, 3 strands can be used, while for brick, for example 2″×4″×8″ brick, only one strand need be used. Once a spacing is chosen, an installer may easily use a spacing gauge for ease of installation.

The strand of this embodiment may be used to reinforce vertical brick veneer walls and decrease the laying time. First, two approximately parallel narrow grout beds are laid down along the length of the wall; they should be approximately as far apart as the depth of the brick, and have a space between them. A single strand is then laid down in the space between the grout beds, and the bricks are laid according to the present invention. In this way, the strand does not interfere with the two grout beds or with buttering the vertical edges of the bricks.

Another advantage of this preferred embodiment is that triple the amount of the previous embodiment can be shipped in the same size package.

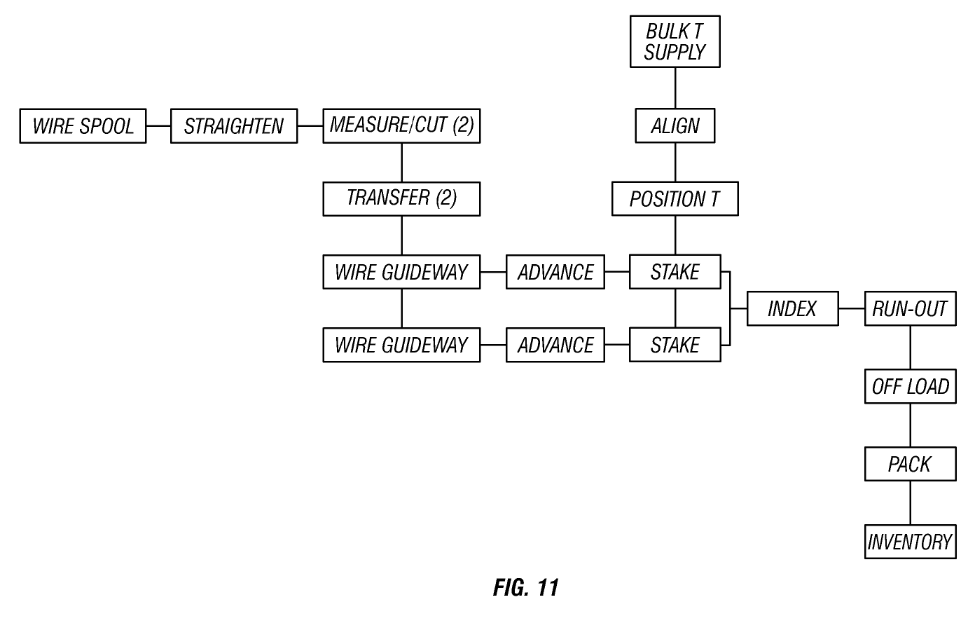

FIG. 11 is a schematic of an example of a method for fabricating a block construction according to the present invention.

The advantages of the present invention include, but are not limited to: providing a continuous tie between building materials; automatically leveling and spacing the modular blocks during laying; providing continuous horizontal reinforcement to each modular block course where a reinforcement or tie line is used; expediting and reducing the laying time, especially the time expended in the leveling or plumbing of each individual modular block; increasing the structural integrity of a modular block, including but not limited to walls and other similar structures (hereafter referred to as a “wall unit(s)”), by significantly decreasing the potential for horizontal or vertical separation between the individual modular block; providing uniform and consistent, horizontal and vertical joint spacing throughout the wall units; providing additional wall unit stability and strength at each modular block point where vertical joining material or fill is used; and providing an easy and efficient method for professional or non-professional use.

The automatic spacing of the present invention allows blocks to be laid without mortar, and then after the construction is complete, plaster or stucco may be sprayed on. Unlike standard modular block construction, the wall sides do not need to be covered with a material, such as masonry adhesive, prior to spraying in order to hide the mortar joints, since there is no mortar. If the vertical pour is thick enough, then it will not come to the surface of the wall. Thus only one step is needed to coat a wall; the final color applying step may also be eliminated.

The present invention may alternate in different configurations, may be placed in the same direction, or may be spaced as appropriate to the building or wall unit. Additionally, the present invention is easily stacked for shipping, handling and other moving.

Alternative embodiments of the present invention include spacers, joiners, and separators in any shape appropriate for the modular blocks. These include but are not limited to any variation in the pin, chamfered or square, grooves, holes and hole placement, and the like.

Another alternative embodiment of the invention includes building wall units with multiple pours, bars instead of pins, and clips includes as supports or corner support.

Alternative embodiments of the present invention include non-injection molded fabrication, use of alternative materials for the present invention, including but not limited to those appropriate for environmentally friendly substitute building materials. Other alternative embodiments are use of the present invention as an artistic component of building such as exposed trusses, or as temporary structural supports for alternative applications including but not limited to camping, mobile or prefabricated homes, or tents/structures for special events.

Although the invention has been described in detail with particular reference to these preferred embodiments, other embodiments can achieve the same results. Variations and modifications of the present invention will be obvious to those skilled in the art and it is intended to cover all such modifications and equivalents. The entire disclosures of all references, applications, patents, and publications cited above and/or in the attachments, and of the corresponding application(s), are hereby incorporated by reference.

What is claimed is:

1. An apparatus for constructing and reinforcing modular block construction, said apparatus comprising:
a plurality of chamfered pins; and
a plurality of connectors connecting said pins; and
wherein said pins automatically align modular blocks placed in a layer above said connectors.

2. The apparatus of claim 1 wherein said pins comprise holes or grooves and said connectors comprise rods, wherein said holes or grooves are sized to engagingly receive ends of said rods.

3. The apparatus of claim 2 wherein a plurality of said pins have two or three holes or grooves receiving three rods, one of said three rods being perpendicular to the other two of said three rods.

4. The apparatus of claim 3 wherein one or more of said pins comprise two holes or grooves receiving two rods, said two rods being perpendicular to one another.

5. The apparatus of claim 2 wherein said pins comprise a rigid, non-porous, water repellent material.

6. The apparatus of claim 5 wherein said pins comprise injection molded plastic.

7. The apparatus of claim 1 wherein said pins are chamfered on two sides of an upwardly extending portion.

8. An apparatus for constructing and reinforcing modular block construction, said apparatus comprising:
a plurality of chamfered pins chamfered on two sides of an upwardly extending portion; and
a plurality of connectors connecting said pins; and
wherein said pins automatically align modular blocks placed in a layer above said connectors.; and
wherein said pins comprise holes or grooves and said connectors comprise rods, wherein said holes or grooves are sized to engagingly receive ends of said rods.

9. The apparatus of claim 8 wherein a plurality of said pins have two or three holes or grooves receiving three rods, one of said three rods being perpendicular to the other two of said three rods.

10. The apparatus of claim 9 wherein wherein one or more of said pins comprise two holes or grooves receiving two rods, said two rods being perpendicular to one another.

11. A method for constructing and reinforcing modular block construction, the method comprising the steps of:
placing on one or more modular blocks a plurality of chamfered pins;
connecting the pins via a plurality of connectors; and
aligning via the pins modular blocks placed in a layer above the connectors.

12. The method of claim 11 wherein in the connecting step the pins comprise holes or grooves and the connectors comprise rods, wherein the holes or grooves are sized to engagingly receive ends of the rods.

13. The method of claim 12 wherein in the connecting step a plurality of the pins have two or three holes or grooves receiving three rods, one of the three rods being perpendicular to the other two of the three rods.

14. The method of claim 13 wherein in the connecting step one or more of the pins comprise two holes or grooves receiving two rods, the two rods being perpendicular to one another.

15. The method of claim 12 wherein in the placing step the pins comprise a rigid, non-porous, water repellent material.

16. The method of claim 15 wherein in the placing step the pins comprise injection molded plastic.

17. The method of claim 11 wherein in the placing step the pins are chamfered on two sides of an upwardly extending portion.

18. A method for constructing and reinforcing modular block construction, the method comprising the steps of:
placing on one or more modular blocks a plurality of chamfered pins chamfered on two sides of an upwardly extending portion;
connecting the pins via a plurality of connectors; and
aligning via the pins modular blocks placed in a layer above the connectors; and
wherein in the connecting step the pins comprise holes or grooves and the connectors comprise rods, wherein the holes or grooves are sized to engagingly receive ends of the rods.

19. The method of claim 18 wherein in the connecting step a plurality of the pins have two or three holes or grooves receiving three rods, one of the three rods being perpendicular to the other two of the three rods.

20. The method of claim 19 wherein in the connecting step the pins wherein one or more of the pins comprise two holes or grooves receiving two rods, the two rods being perpendicular to one another.
